(19) United States
(12) Patent Application Publication
(10) Pub. No.: US 2016/0154481 A1
(43) Pub. Date: Jun. 2, 2016

(54) INTELLIGENT ILLUMINATION OF CONTROLLERS

(71) Applicant: Comcast Cable Communications, LLC, Philadelphia, PA (US)

(72) Inventors: Michael Sallas, Radnor, PA (US); Edward R. Grauch, Philadelphia, PA (US); Ross Gilson, Philadelphia, PA (US); Mariel Sabraw, Philadelphia, PA (US)

(21) Appl. No.: 14/557,991

(22) Filed: Dec. 2, 2014

(51) Int. Cl. G06F 3/038; G06F 3/041

(52) U.S. Cl. CPC G06F 3/0383; G06F 3/041

(57) ABSTRACT

Systems and methods for intelligent illumination of a controller are disclosed. One method comprises receiving, by a computing device, first information relating to a current environment of a controller, wherein the controller comprises a plurality of user engageable interfaces, and wherein at least a subset of the user engageable interfaces is configured to be independently and selectively illuminated. Second information can be received relating to a current operating state of the controller. A portion of the plurality of user engageable interfaces can be selectively illuminated based upon at least the first information and the second information.

### BACKGROUND

Various controllers can be configured to control user devices, such as, televisions, communication terminals, receivers, and the like. Such controllers often have a pre-defined number of inputs or buttons, and can be programmed to enable control of various user devices. The controllers often have backlighting to illuminate the buttons for easy viewing.

### SUMMARY

It is to be understood that both the following general description and the following detailed description are exemplary and explanatory only and are not restrictive. Current solutions for managing illumination of the inputs, such as hard or soft buttons are generically applied and result in illumination of unneeded buttons, unnecessarily reducing battery life of the controller. These and other shortcomings are addressed by the present disclosure. Provided are methods and systems for managing controllers and illumination of the same.

In an aspect, a method can comprise receiving first information relating to a current environment of a controller. The controller can comprise a plurality of user engageable interfaces. At least a portion of the user engageable interfaces can be configured to be independently and selectively highlighted or emphasized, e.g., illuminated. Second information can be received. The second information can relate to a current operating state of one or more of the controller and a controlled device. The current operating state can comprise one or more of a location, an orientation, a relative position of the controller and the controlled device, and a use of the one or more of the controller and a controlled device. An illumination signature for the controller can be determined, for example, based at least in part on the received first information and the received second information. Illumination of only a subset of the plurality of user engageable interfaces can be caused based upon the illumination signature.

In an aspect, a controller can comprise a housing with a communication element disposed adjacent the housing. The communication element can be configured to transmit a signal for controlling operations of a controlled device. A plurality of user engageable interfaces can be disposed adjacent the housing. As an example, at least a subset of the user engageable interfaces can be configured to be independently and selectively illuminated. As a further example, the user engageable interfaces can be configured to be activated by a user to cause the signal to be transmitted for controlling operations of the controlled device. A processor can be disposed within the housing and can be configured to receive information relating to one or more of an environment of the controller and an operating condition of the controller. The processor can be configured to cause illumination of a portion of the plurality of user engageable interfaces based upon received information. The environment can comprise one or more of ambient light, time of day, weather conditions, ambient sound level, or premises security state, or a combination thereof, and the operating state can comprise one or more of a location, an orientation, a relative position to a controlled device, and a use of the controller.

In an aspect, a method can comprise receiving first information relating to a current environment of a controller. The controller can comprise a plurality of user engageable interfaces. At least a subset of the user engageable interfaces is configured to be independently and selectively illuminated. Second information can be received relating to a current operating state of one or more of the controller and a controlled device. A portion of the plurality of user engageable interfaces can be caused to selectively illuminate based upon at least the first information and the second information.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a schematic diagram of an example controller;

FIG. 2 is a block diagram of the example controller of FIG. 1;

FIG. 3 is a block diagram of an example system and network;

FIG. 4 is a perspective view of an example user environment;

FIG. 5 is a perspective view of an example user environment;

FIG. 6 is a flow chart of an example method;

FIG. 7 is a flow chart of an example method; and

FIG. 8 is a block diagram of an example computer.

### DETAILED DESCRIPTION

In an aspect, a controller can be configured to transmit a signal for controlling operations of a controllable device. The controller can have a plurality of user engageable interfaces (e.g., buttons, portions of a touch screen, etc.) configured to be activated by a user to cause the signal to be transmitted for controlling operations of the controlled device. In certain instances, ambient light in the environment of the controller may not be bright enough to allow a user to see the interfaces or to differentiate one interface from another. As such, at least a subset of the user engageable interfaces can be configured to be independently and selectively illuminated to provide backlighting to the interfaces. As an example, illumination of at least portion of the plurality of user engageable interfaces can be based upon received information such as environmental information (e.g., detected ambient light, time of day, weather conditions, ambient sound level, premises security state, or a combination thereof) or an operating state such as location, an orientation, a relative position to a controlled device, and a current or past use of the controller. The controller with selectively and intelligently controllable illumination patterns can provide a user with appropriate lighting for necessary interfaces based upon real-time information relating to the current use of the controller and/or the state of the controlled device. The selective illumination can also be implemented to indicate alerts or other communications to a user. Such controlled illumination can conserve battery power and provide an improved user experience.

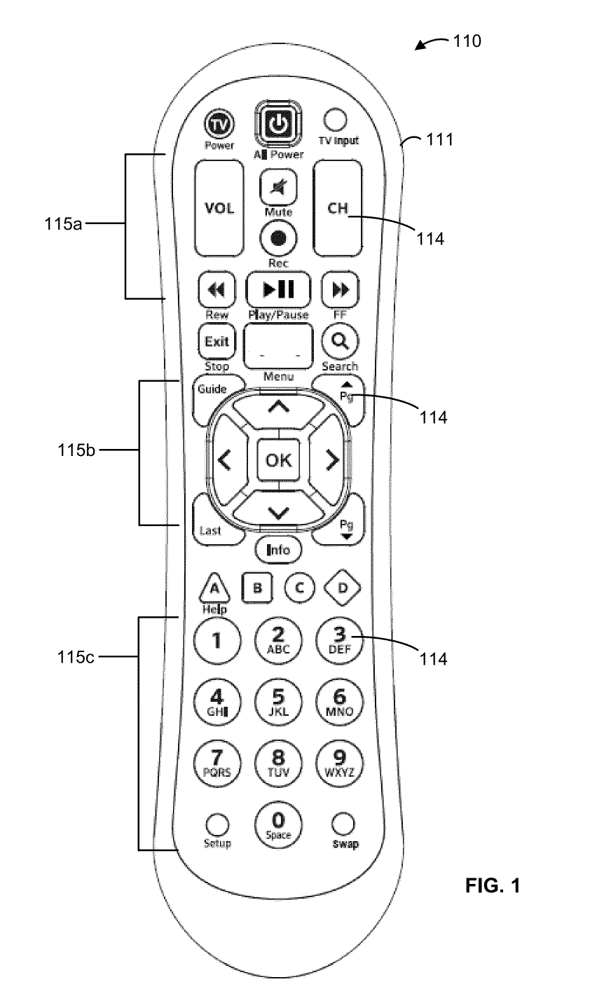

FIGS. 1-3 illustrate various aspects of an example controller 110 and a system in which the controller 110 can operate. In an aspect, the controller 110 can be a remote controller configured to communicate with one or more devices via wired and/or wireless communication (e.g., radio frequency, infrared, WiFi, Bluetooth, etc.). As an example, the controller 110 can be software executed by a computing device (e.g., mobile device, handheld device, tablet, computer, second screen device, etc.). As a further example, the controller 110 can be any hardware and/or software configured to communicate with a device to control functions associated with the device. In an aspect, once the controller 110 has the means to control a particular device, the controller 110 is paired with the particular device (e.g., has established a control relationship with the particular device). In an aspect, the controller 110 can establish a control relationship with one or more devices to facilitate control of the one or more device via the controller 110. As an example, the control relationship can be active or inactive to provide selective control over one or more of a plurality of devices.

In an aspect, the controller 110 can comprise a housing 111. The housing 111 can have any shape and size. As an example, the housing 111 can be configured to be grasped by a user to facilitate the user's interaction with the controller 110.

A communication element 112 can be disposed adjacent at least a portion of the housing 111 and configured to transmit a signal for controlling operations of a device (e.g., paired device, broadcast device, etc.). The housing 111 can at least partially enclose the communication element 112. A controlled device can comprise any device configured to process the signals received from the controller 110. As an example, the communication element 112 can be configured to transmit and/or receive signals via one or more of a light spectrum or a radio frequency spectrum. As an example, the communication element 112 can be configured to communicate via infrared, Bluetooth, near field, WiFi, and/or protocols or communication standards.

A plurality of user engageable interfaces 114 can be disposed adjacent at least a portion of the housing 111. The housing 111 can be configured with one or more apertures to facilitate access to an inlaid one or more of the interfaces 114. The interfaces 114 can be configured to be activated by a user to cause the signal to be transmitted for controlling operations of the controlled device. The interfaces 114 can comprise a button, a touch screen surface, a switch, a motion sensor, or a combination thereof. Other interfaces can be used. In an aspect, at least a subset 115a, 115b, 115c of the interfaces 114 can be configured to be independently and selectively illuminated. As an example, one or more of the interfaces 114 can be grouped into one or more subsets 115a, 115b, 115c. The one or more subsets 115a, 115b, 115c can be associated with particular function sets such as functions relating to a particular controllable device or operation. For example, a first subset 115a can be configured to control content operations such as trick play and selections relating to video on demand content. As another example, a second subset 115b can be configured to control menu and/or guide options. As a further example, a third subset 115c can be configured to control device operations such as audio control and or tuning controls. The subsets 115a, 115b, 115c can comprise any number of interfaces 114 and can be associated with any operations or devices.

One or more lighting elements 116 can be configured to provide light to the interfaces 114. The lighting elements 116 can be selectively and independently controlled to provide a customized lighting pattern of the interfaces 114. As an example, the lighting elements 116 can be selectively and independently controlled to provide a customized lighting pattern of the interfaces 114 of a particular subset 115a, 115b, 115c. The lighting elements 116 can comprise light emitting diodes, liquid crystal, and/or other material configured to emit light. The lighting element s 116 can receive electrical energy via a power source 117 such as a stored energy source (e.g., battery) or in-time energy source.

A processor 118 can be configured to receive information relating to one or more of an environmental condition of the controller 110 and an operating condition of the controller 110. As an example, the environmental condition may comprise one or more of ambient light, time of day, weather conditions, ambient sound level, or premises security state, or a combination thereof. As a further example, the operating state may comprise one or more of a location, an orientation, a relative position to a controlled device, and a use of the controller and/or a state of the controlled device. The processor 118 can be at least partially enclosed by the housing 111. As an example, the processor 118 can be configured to cause illumination of at least a portion of the interfaces 114. As another example, the processor 118 can be configured to control the illumination of the interfaces 114 based upon the received information. The illumination of the interfaces 114 can comprise illumination in a pre-determined illumination pattern such as a pattern of select ones (e.g., subsets 115a, 115b, 115c) of the interfaces 114 or a sequence of illuminated interfaces 114.

In an aspect, the controller 110 can comprise a state element 119 configured to receive (e.g., access, determine, measure, detect, passively receive, etc.) information relating to a state of the controller 110 and/or a state of the controlled device. As an example, the state element 119 can be configured to receive information relating to one or more of an environmental condition of the controller 110 and an operating condition of the controller 110. As an example, the environmental condition may comprise one or more of ambient light, time of day, weather conditions, ambient sound level, or premises security state, or a combination thereof. As a further example, the operating state may comprise one or more of a location, an orientation, a relative position to a controlled device, and a use of the controller. The state element 119 can comprise a sensor such as a light sensor, temperature sensor, pressure sensor, and the like. The state element 119 can comprise a position sensor such as a compass, altimeter, gyroscope, global positioning system, and/or a device or logic that can support position discovery. The state element 119 can be in communication with remote sensors and configured to receive information from the remote sensors. As an example, information can be received from a sensor disposed adjacent the housing of the controller, a device configured to be controlled by the controller, a premises security system, a communication gateway, or a network device, or a combination thereof. The information can comprise use information such as habitual use, historical use, patterns, user preferences, aggregate user patterns, and the like.

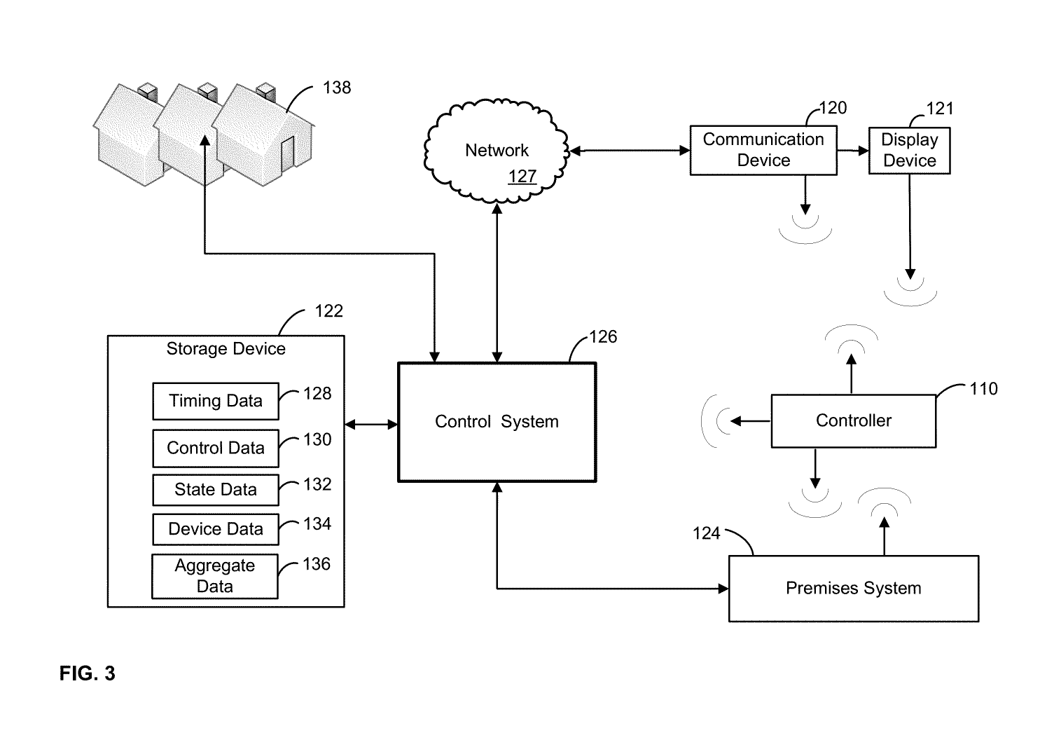

FIG. 3 illustrates an example system and network in which the controllers and methods of the disclosure can operate. In an aspect, a communication device 120, such as a network gateway, communications terminal (CT), set-top box, user device (e.g., tablet, smart phone, portable computer, personal computer, etc.) The communication device 120 can be configured to decode, if needed, signals for display on a display device 121, such as on a television set (TV) or a computer monitor. Various wireless devices may also be connected to the network at, or proximate, a location of the controller 110. As an example, a storage device 122 can be in communication with one or more of the communication device 120 and the display device 121 to send/receive data therebetween. As a further example, the storage device 122 can be located remotely from the controller 110, such as a network storage. In an aspect, a software such as an operating software, control software, or application software can be stored on the storage device 122.

In an aspect, a premises system 124 can be configured to monitor and or control an environment such as a premises (e.g., enclosure, house, office, etc.). As an example, the premises system 124 can comprise a premises security system. The security system can detect motion of objects within or near the premises. The security can detect the opening of entries such as windows or doors. As a further example, the premises system 124 can comprise an automated premises system configured to control HVAC, premises lighting, electronics, entry locks, automated systems, water systems, appliances, and the like. The automated premises system can be configured to measure environmental conditions such as ambient light, temperature, pressure, humidity, and the like.

In an aspect, one or more of the communication device 120, the premises system 124, or other device or system can be in communication with a control system 126 or device or element. The control system 126 can be disposed remotely from one or more of the communication device 120 and/or the premises system 124 and in communication via a network 127. As an example, the control system 126 can be integrated with the controller 110. As another example, the control system 126 can comprise control software for managing one or more operational functions of the controller 110. As a further example, the control system 126 can be integrated with one or more of the communication device 120, the premises system 124, or other device or system. The control system 126 can be configured to communicate (e.g., wired or wirelessly, uni-directionally or bi-directionally, over RF, IR, WiFi, Bluetooth, and/or other protocols or spectrums) with a controller such as controller 110. As an example, the control system 126 can be configured to receive, transmit, and/or process information relating to an environment of the controller 110. As an example, the control system 126 can be configured to communicate with controller 110 to cause selective illumination of the lighting elements 116 of the controller 110.

In an aspect, the control system 126 can be in communication with the storage device 122 or storage medium. The storage device 122 can be disposed remotely from one or more of the control system 126, the communication device 120, the premises system 124, and the controller 110. For example, the storage device can be located at central location, in the cloud, at a third-party location, and the like. As a further example, the storage device 122 can be integrated or disposed in one or more of the communication device 120, the premises system 124, and the controller 110.

In an aspect, the storage device 122 can comprise one or more of timing data 128, control data 130, state data 132, device data 134, and/or aggregate data 136. Other data can be stored on and retrieved from the storage device 122.

In an aspect, the timing data 128 can be a time stamp or other time marker for indicating, for example, a date and/or time associated with one or more of a transmission of content, a request for content, a request for playback, storage of content, deletion of content, a time of paring, a time of day, or the execution of a particular control function. As an example, the timing data 128 can comprise any number of time-related entries and/or markers. As a further example, the timing data 128 can comprise one or more of a table of time-related data entries, a timing log, and a database of time-related information. Other information can be stored as the timing data.

In an aspect, the control data 130 can comprise information relating to characteristics and parameters associated with a particular controller and/or controllable functions of one or more devices. In an aspect, the control data 130 can comprise information relating to the interfaces 114 of a particular controller. As an example, when a user configures a tablet or touch screen device to operate as a remote controller, the control data can comprise information relating to the communication protocol(s) associated with the tablet and/or the user interface elements rendered on the tablet. As a further example, the control data 130 can comprise information relating to the association of one or more interfaces 114 and the transmission of control signals via one or more protocols and/or transmission channels.

In an aspect, the state data 132 can comprise information relating to a state of the controller 110. As an example, the state data 132 can relate to one or more of an environmental condition of the controller 110 and an operating condition of the controller 110. The state data 132 can comprise use information such as habitual use, historical use, patterns, user preferences, aggregate user patterns, and the like. As an example, the environmental condition can comprise one or more of ambient light, time of day, weather conditions, ambient sound level, or premises security state, or a combination thereof. As a further example, the operating state can comprise one or more of a location, an orientation, a relative position to a controlled device, and a use of the controller. As a further example, the state data 132 can be received from a sensor disposed adjacent the housing of the controller, a device configured to be controlled by the controller, a premises security system, a communication gateway, or a network device, or a combination thereof. Other parameters or contexts relating to a condition or environment of the controller 110 can be used to determine a state of the controller 110.

In an aspect, the device data 134 can comprise information relating to one or more controllable devices. As an example, the device data 134 can comprise information for one or more devices relating to manufacturer, model, series, version, device type, and the like. As a further example, the device data 134 can be associated with the state data 132 such that a particular device having a particular manufacturer may be associated with particular state data 132. The device data 134 can comprise information relating to one or more control relationships between the controller 110 and one or more devices (e.g., communication device 120, premises system 124, etc.). In an aspect, device data 134 can comprise information relating to a state of the controller 110 that is associated with a control relationship between the controller 110 and one or more devices. As an example, the state of the controller 110 at the time a control relationship is established with a particular device can be associated with the device data 134.

In an aspect, the aggregate data 136 can comprise information relating to a plurality of controllers 110 being used in various locations such as user premises 138. For example, one or more of timing data 128, control data 130, state data 132, and device data 134 can be received by one or more control systems 126 and can be processed to aggregate the received data. As such, habits, patterns, statistical information, and the like can be determined based upon operational information received from a plurality of controllers 110 and related devices or users. The aggregate data 136 can be used to define a normal operation based on multiple users rather than a single user's use of the controller. Individual habits and preferences can be delineated from the aggregate habits and preferences and both individual and aggregate information can be leveraged to provide a user experience.

For example, a component, such as the state element 119 and/or control system 126, can analyze an input (e.g., timing data 128, control data 130, state data 132, device data 134, and/or aggregate data 136) to provide a “signature” of the input. The signature can also be referred to as a fingerprint or other nomenclature to define a pattern of operation that can be delineated from other operations. The signature of the input can be represented by the state data 132 provided by the state element 119 of one or more controllers 110. The signature of the input can be compared to a digital library (e.g., data on storage device 122 or other storage medium) that associates the signature of the input with a predetermined illumination process. Accordingly, one or more of the lighting elements 116 of one or more controllers 110 can be configured to illuminate at least a portion of the one or more controllers 110 in an illumination pattern based on the determined signature. As an example, a signature can be determined based on a user's interaction with the controller 110 at a particular time of day. As a further example, the signature represent that the user only interacts with interfaces 114 controlling volume and channel tuning during weekday evenings. As such, the lighting elements 116 associated with the user's controller 110 can be configured to illuminate only interfaces 114 controlling volume and channel tuning during weekday evenings. Once the user breaks out of the signature pattern, other signatures can be recognized or a default illumination process can be implemented. As a further example, a signature can be determined based upon the aggregate data 136 representing operational habits of a plurality of users. The aggregate signature can represent that users watching on demand content or recorded content only mostly interact with a subset of interfaces (e.g., subset 115a (FIG. 1)). As such, when it is determined that a user is watching on demand content, the lighting elements 116 associated with the user's controller 110 can be configured to illuminate only the subset of interfaces 114 relating to on demand controls. Current behavior of a particular user can be determined by one or more of the state element 119 and/or control system 126 or other device in communication with the controller 110 and can be local or remote to the controller 110.

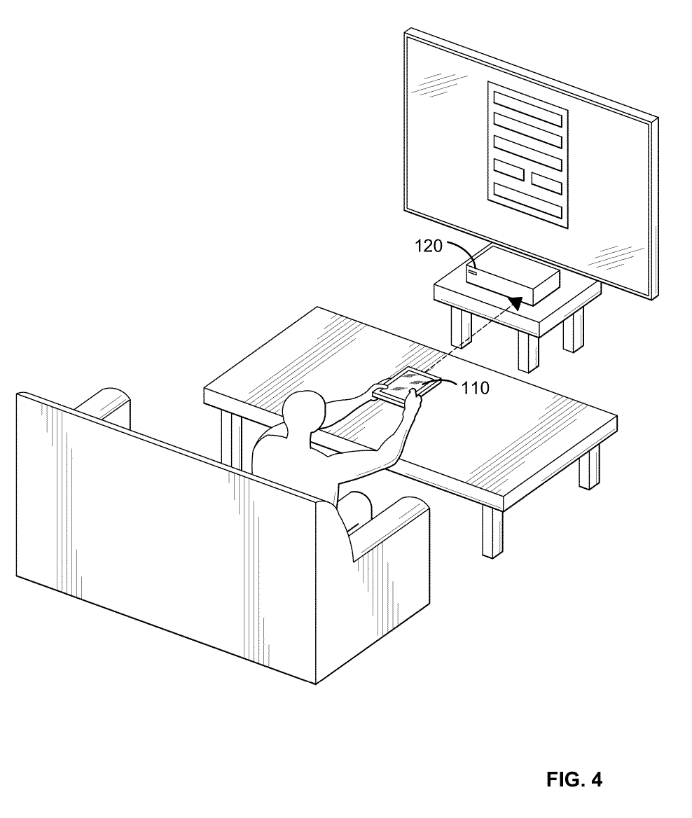

FIG. 4 illustrates an exemplary user environment in which the systems and methods can operate. In an aspect, the controller 110 can be oriented toward a particular device, such as display device 121. As such, the state of the controller 110 can relate to the orientation of the controller 110. However, the state of the controller 110 can relate to other parameters. As an example, a state data representing the current state of the controller 110 can be compared to a stored state data (e.g., state data 132, device data 134, aggregate data 136, etc.). If the current state data of the controller 110 substantially matches the stored state data, the controller 110 can be automatically configured to illuminate at least a portion of the interfaces in an illumination pattern. As a further example, the current state data of the controller 110 can comprise one or more of a location, position, and/or orientation. As shown in FIG. 4, the current state data of the controller 110 can be matched to a stored state data that is associated with the control of display device 121. Accordingly, the interfaces associated operational controls of the display device 121 can be automatically illuminated.

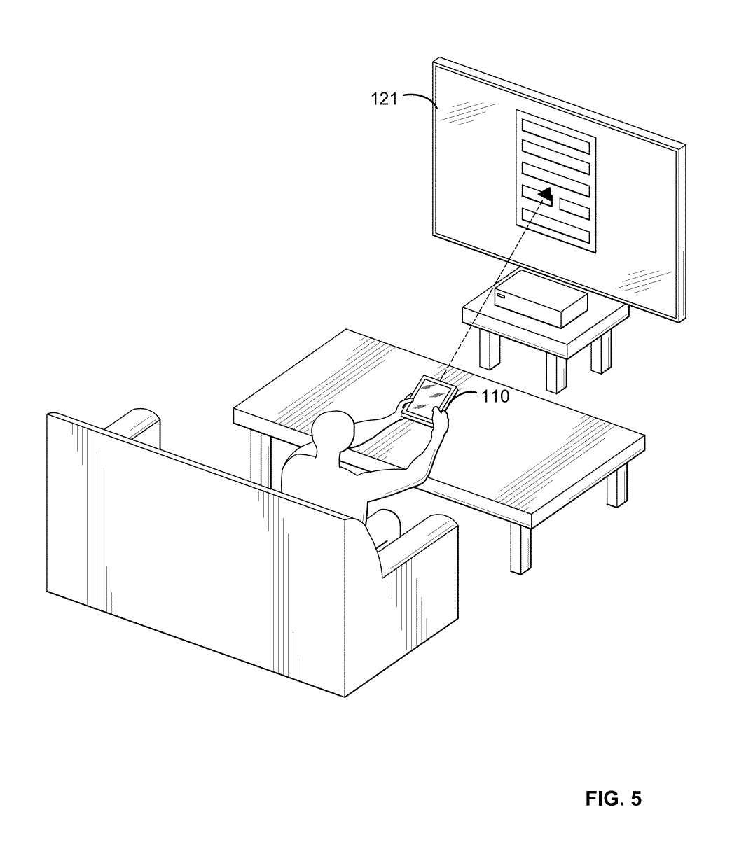

FIG. 5 illustrates an exemplary user environment in which the systems and methods can operate. In an aspect, the controller 110 can be oriented toward a particular device, such as communication device 120. As such, the state data of the controller 110 can comprise information relating to the orientation of the controller 110. However, the state data of the controller 110 can comprise other data points and parameters. As an example, the state data of the controller 110 can be compared to a stored state data (e.g., state data 132, device data 134, aggregate data 136, etc.). If the current state data of the controller 110 substantially matches the stored state data, the controller 110 can be automatically configured to illuminate at least a portion of controller 110 (e.g., select interfaces 114) in an illumination pattern. As shown in FIG. 5, the current state data of the controller 110 can be matched to a stored state data that is associated with the control of the communication device 120. Accordingly, the interfaces associated operational controls of the communication device 120 can be automatically illuminated.

In an aspect, one or more of the lighting elements 116 can be selectively illuminated when the processor 118 determines the controller 110 has a particular orientation. For example, the lighting elements 116 can be illuminated when the controller 110 is right-side up (e.g., interfaces 114 facing the user) and turned off when the controller 110 is upside-down. Other positions can be used to control the lighting elements 116.

In an aspect, the state element 119 can receive information such as a time from a settop box and the lighting elements 116 can be illuminated at night and not during the day. In another aspect, the premises system 124 can determine ambient light conditions or premises conditions affecting ambient light such as premises lights are one or off, window shades are down, etc. Such information from the premises system 124 can be used to make decisions about illuminating at least a portion of the controller 110.

In an aspect, user behavior can be determined and processed to define a signature of behavior. Various signatures can be determined such as thresholds or rules based on received data relating to one or more of environmental conditions and operational conditions relating to the controller 110. For example, if ambient light in an environment of the controller 110 is above a certain pre-defined threshold, the controller 110 will not be illuminated. Such ambient light can be measured using sensors disposed in the controller 110 or by other systems or devices in the environment of the controller 110. Other contextually information can be used to determine the ambient light conditions such as status of automated window shades, time of day, positions of light switches or dimmer switches in the premise, etc. For example, if it is daytime and the user is holding the controller 110, the ambient lights are off, and the window shades are down or there are no windows in the room containing the controller 110, then an illumination pattern can be implemented to selectively illuminate at least a portion of the controller, for example at a defined intensity level. Similarly, if there are windows in the room and the window shades are open, then an illumination pattern can be implemented to limit or prevent illumination of the controller 110.

In an aspect, the premises system 124 can comprise a premises security camera that is in the same room, or has a view of the room in which the controller 110 is located. The camera can be used to determine environmental and/or operational conditions affecting the state of the controller 110. For example, white balance information can be received from the camera, for example, to gauge the overall brightness level of the room. As such, an intensity of the illumination of the controller 110 can vary inversely with input from the camera. More advanced image processing can be implemented to track the controller 110 within the camera's field of view and to determine the brightness around (e.g., within a predefined region) the controller 110 itself. For example, such a localized brightness determination can be used to account for a bright light in another room within the field of view of the camera, while the controller 110 is being used in a dark room. A minimum brightness level or average brightness level around the controller 110 can be calculated to account for the light level emitted from the controlled device (e.g., television). Even more complex, the light level of the video source could be precalculated (if it was recorded) so if there is a very bright scene for the next 30 seconds, remote control backlighting may not be necessary.

In addition to supporting a smart backlighting system, the state element 119 could be leveraged during pairing to validate that the controller 110 is pairing with the intended controllable device. For example, if a light sensor (e.g., state element 119) on the controller 110 tracks ambient light data for a given environment, and the controllable device with which it is attempting to pair tracks data corresponding to the same environment, there can be a high level of confidence that the controller 110 is pairing with the intended controllable device. As a further example, an optical authentication process can be implemented when the controllable device (or controller 110) can communicate with a lighting controller to adjust the intensity, flash the light, or change the color/hue of the room in a defined sequence, thereby communicating an optical signal sequence to the light sensor. Various sequences can be used to communicate to various devices and controllers to selectively pair devices. Such sequences can also be implemented via minor adjustments that are imperceptible to the user.

In an aspect, the lighting elements 116 of the controller 110 can be used as a notification system to alert the user. For example, the premises system 124 can comprise a home security system that can detect an opening of a door or window and alert a user with an audio alert. However, when a user is in front of the TV, the audio of the TV can interfere with audio alert from the premises system, 124. To account for this, the illumination pattern of the controller 110 can be configured to communicate a visual alert to the user, for example, blink 3 times if a door is opened. The controller 110 could also blink a number of times, or in a specific pattern for specific doors, to let the user know what door has been opened. Vibration or other tactile feedback, or speakers can also be used in the controller 110. Controls from the controller 110 can be automated alone or in conjunction with an alert. As a further example, the controller 110 or another device/system (e.g., telephony system, home automation) can automatically mute the TV when the doorbell is activated or a home telephone is ringing. Other information received from the premises system 124 or other device can be used to determine a feedback to the user.

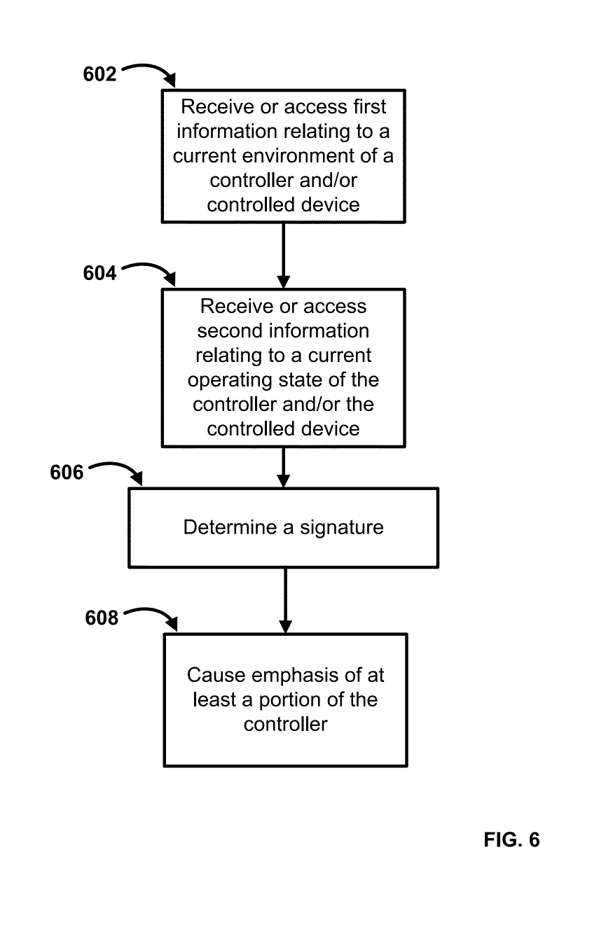

FIG. 6 illustrates an example method for illuminating a controller. As an example, the controller can comprise a plurality of user engageable interfaces. As a further example, at least a portion of the user engageable interfaces are configured to be independently and selectively illuminated. In an aspect, the user engageable interfaces can comprise one or more of back-lit keys and a touch screen.

In operation 602, first information can be received or accessed. In an aspect, the first information can relates to a current environment of a controller and/or controlled device (e.g., a device configured to be controlled by the controller). As an example, the first information can comprise ambient light level. As another example, the first information can comprise time of day, weather conditions, ambient sound level, or premises security state, or a combination thereof. As a further example, the first information can be received from a sensor co-located with the controller, the controlled device, a premises security system, a communication gateway, or a network device, or a combination thereof. Other information can be received from other sources.

In operation 604, second information can be received or accessed. In an aspect, the second information can relate to a current operating state of the controller and/or controlled device (e.g., a device configured to be controlled by the controller). As an example, the current operating state can comprise one or more of a location, an orientation, a relative position of the controller and the controlled device, and a use of the controller and/or the controlled device. As a further example, the second information can be received from a sensor co-located with the controller, the controlled device, a premises security system, a communication gateway, or a network device, or a combination thereof. The operating state of the controller and/or the controlled device can relate to certain functions or a user experience that is being provided. For example, when the controlled device can be operating in a state or mode where trick play is available or where no trick play is available. The controlled device can be causing presentation of non-interactive content or interactive content. Submenus and options can be represented by the second information. Other operational information such as information relating to features being leveraged or presented can be included in the second information.

In operation 606, a signature such as an illumination signature can be determined. In an aspect, the illumination signature (or other signature) can be based at least in part on the received first information and the received second information. As an example, the illumination signature can represent a pattern of conditional values relating to at least the environment and operating state of the controller and/or the controlled device. As a further example, the illumination signature can be based at least in part on one or more of historical data for the controller and/or the controlled device, predictive data for the controller and/or the controlled device, and aggregated data with at least one other controller and/or controlled device.

In operation 608, at least a portion of the controller can be emphasized such as via illumination. In an aspect, a subset of the plurality of user engageable interfaces can be caused to illuminate based upon the illumination signature. As an example, the illumination of only the subset of the plurality of user engageable interfaces can comprises causing illumination in a pre-determined illumination pattern such as a sequence or selective portions of the controller. In another aspect, one or more soft buttons or icons can be presented via a display and can be altered so that a subset of the soft buttons can be emphasized. As an example, the subset of the soft buttons can be increased in size relative to other buttons. In certain aspects, the operating state of the controller and/or the controlled device can relate to certain functions or a user experience that is being provided and emphasis can be controlled in response to the particular user experience. As an example, certain portions of the controller that are not necessary for the particular interaction or function can remain un-emphasized or can be de-emphasized. For example, when the controlled device is operating in a state or mode where no trick play is available, then the trick play buttons will not be emphasized. As another example, where the controlled device in its then current state (e.g., showing non-interactive content, therefore not requiring buttons needed for interactivity) does not need certain functionality, then the portions of the controller (e.g., buttons) relating to that functionality are not illuminated/emphasized. As a further example, the controlled device can transmit such information to the controller, and the controller can act on it.

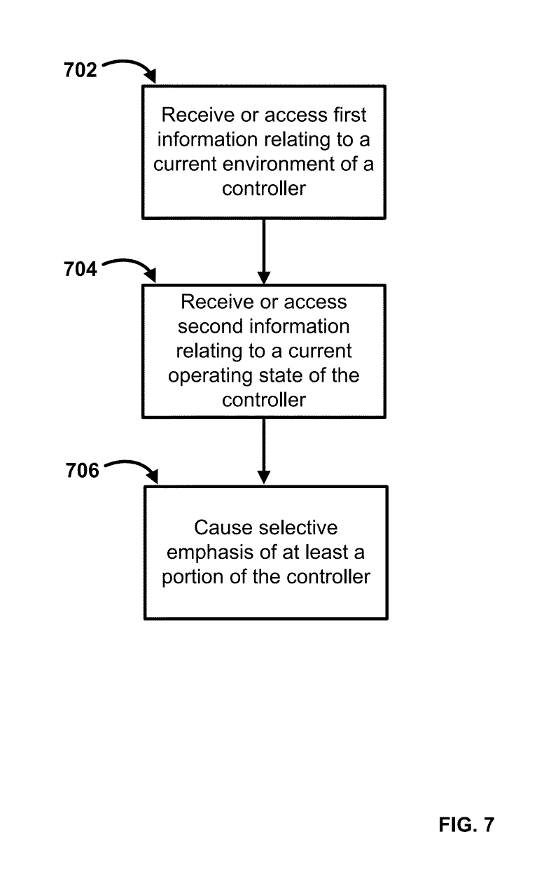

FIG. 7 illustrates an example method for illuminating a controller. As an example, the controller can comprise a plurality of user engageable interfaces. As a further example, at least a portion of the user engageable interfaces are configured to be independently and selectively illuminated. In an aspect, the user engageable interfaces can comprise one or more of back-lit keys and a touch screen.

In operation 702, first information can be received or accessed. In an aspect, the first information can relates to a current environment of a controller. As an example, the first information can comprise ambient light level. As another example, the first information can comprise comprises time of day, weather conditions, ambient sound level, or premises security state, or a combination thereof. As a further example, the first information can be received from a sensor co-located with the controller, a device configured to be controlled by the controller, a premises security system, a communication gateway, or a network device, or a combination thereof. Other information can be received from other sources.

In operation 704, second information can be received or accessed. In an aspect, the second information can relate to a current operating state of the controller. As an example, the current operating state can comprise one or more of a location, an orientation, a relative position to a controlled device, and a use of the controller. As a further example, the second information can be received from a sensor co-located with the controller, a device configured to be controlled by the controller, a premises security system, a communication gateway, or a network device, or a combination thereof.

In operation 706, at least a portion of the controller can be emphasized, such as via illumination. In an aspect, a subset of the plurality of user engageable interfaces can be selectively caused to illuminate. As an example, a portion of the plurality of user engageable interfaces can be illuminated based upon at least the first information and the second information. The illumination of the controller can be based on a pre-determined illumination pattern such as a sequence or selective portions of the controller. As another example, the pre-determined illumination pattern represents a notification message, for example an alert intended for the user of the controller. As a further example, one or more interfaces of the plurality of user engageable interfaces can be determined to be necessary based upon at least the first information and the second information, and the necessary interfaces can be illuminated.

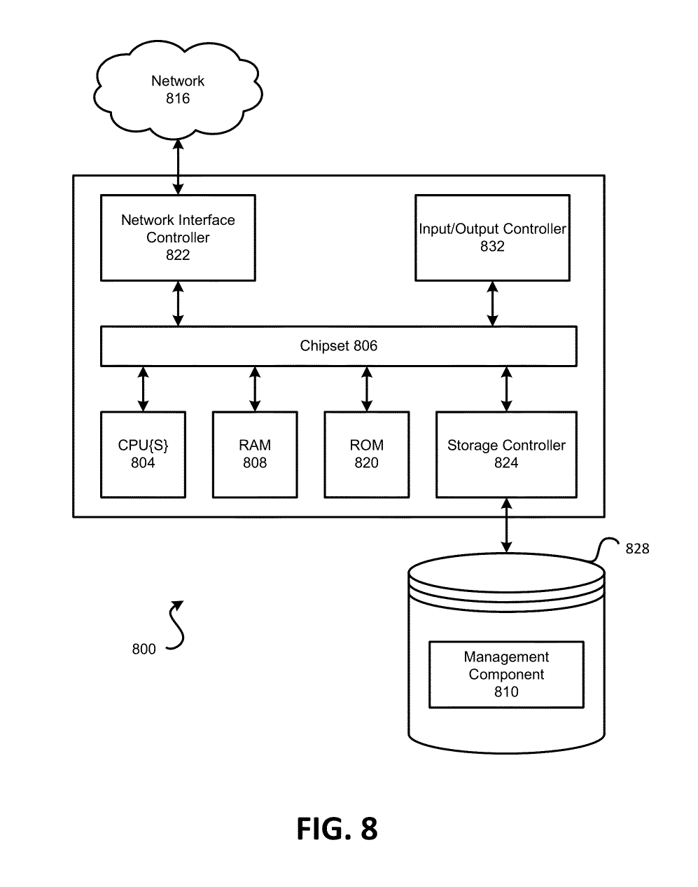

FIG. 8 depicts a computer that may be used in aspects, such as the computers depicted in FIG. 1. With regard to the example architecture of FIG. 3, communication device 120, premises system 124, and control system 126 may each be implemented in an instance of computer 800 of FIG. 8. The computer architecture shown in FIG. 8 illustrates a conventional server computer, workstation, desktop computer, laptop, tablet, network appliance, PDA, e-reader, digital cellular phone, or other computing node, and may be utilized to execute any aspects of the computers described herein, such as to implement the operating procedures of FIGS. 6-7.

Computer 800 may include a baseboard, or “motherboard,” which is a printed circuit board to which a multitude of components or devices may be connected by way of a system bus or other electrical communication paths. One or more central processing units (CPUs) 804 may operate in conjunction with a chipset 806. CPUs 804 may be standard programmable processors that perform arithmetic and logical operations necessary for the operation of computer 800.

CPUs 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

Chipset 806 may provide an interface between CPUs 804 and the remainder of the components and devices on the baseboard. Chipset 806 may provide an interface to a random access memory (RAM) 808 used as the main memory in computer 800. Chipset 806 may further provide an interface to a computer-readable storage medium, such as a read-only memory (ROM) 820 or non-volatile RAM (NVRAM) (not shown), for storing basic routines that may help to start up computer 800 and to transfer information between the various components and devices. ROM 820 or NVRAM may also store other software components necessary for the operation of computer 800 in accordance with the aspects described herein.

Computer 800 may operate in a networked using logical connections to remote computing nodes and computer systems through local area network (LAN) 816. Chipset 806 may include functionality for providing network connectivity through a network interface controller (NIC) 822, such as a gigabit Ethernet adapter. NIC 822 may be capable of connecting the computer 800 to other computing nodes over network 816. It should be appreciated that multiple NICs 822 may be present in computer 800, connecting the computer to other types of networks and remote computer systems.

Computer 800 may be connected to a mass storage device 828 that provides non-volatile storage for the computer. Mass storage device 828 may store system programs, application programs, other program modules, and data, which have been described in greater detail herein. Mass storage device 828 may be connected to computer 800 through a storage controller 824 connected to chipset 806. Mass storage device 828 may consist of one or more physical storage units. Storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

Computer 800 may store data on mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether mass storage device 828 is characterized as primary or secondary storage and the like.

For example, computer 800 may store information to mass storage device 828 by issuing instructions through storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. Computer 800 may further read information from mass storage device 828 by detecting the physical states or characteristics of one or more particular locations within the physical storage units.

In addition to mass storage device 828 described above, computer 800 may have access to other computer-readable storage media to store and retrieve information, such as program modules, data structures, or other data. It should be appreciated by those skilled in the art that computer-readable storage media can/may be any available media that provides for the storage of non-transitory data and that may be accessed by computer 800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (EPROM), electrically erasable programmable ROM (EEPROM), flash memory or other solid-state memory technology, compact disc ROM (CD-ROM), digital versatile disk (DVD), high definition DVD (HD-DVD), BLU-RAY, or other optical storage, magnetic cassettes, magnetic tape, magnetic disk storage, other magnetic storage devices, or any other medium that can may be used to store the desired information in a non-transitory fashion.

Mass storage device 828 may store an operating system utilized to control the operation of the computer 800. According to one embodiment, the operating system comprises a version of the LINUX operating system. According to another embodiment, the operating system comprises a version of the WINDOWS SERVER operating system from the MICROSOFT Corporation. According to further aspects, the operating system may comprise a version of the UNIX operating system. It should be appreciated that other operating systems may also be utilized. Mass storage device 828 may store other system or application programs and data utilized by computer 800, such as management component 810 and/or the other software components described above.

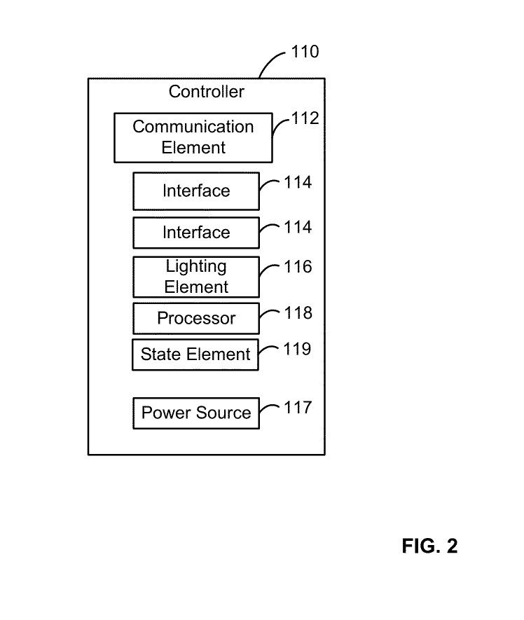

Mass storage device 828 or other computer-readable storage media may also be encoded with computer-executable instructions, which, when loaded into computer 800, transforms the computer from a general-purpose computing system into a special-purpose computer capable of implementing the aspects described herein. These computer-executable instructions transform computer 800 by specifying how CPUs 804 transition between states, as described above. Computer 800 may have access to computer-readable storage media storing computer-executable instructions, which, when executed by computer 800, may perform operating procedures depicted in FIGS. 2-5.

Computer 800 may also include an input/output controller 832 for receiving and processing input from a number of input devices, such as a keyboard, a mouse, a touchpad, a touch screen, an electronic stylus, or other type of input device. Similarly, input/output controller 832 may provide output to a display, such as a computer monitor, a flat-panel display, a digital projector, a printer, a plotter, or other type of output device. It will be appreciated that computer 800 may not include all of the components shown in FIG. 8, may include other components that are not explicitly shown in FIG. 8, or may utilize an architecture completely different than that shown in FIG. 8.

As described herein, a computing node may be a physical computing node, such as computer 800 of FIG. 8. A computing node may also be a virtual computing node, such as a virtual machine instance, or a session hosted by a physical computing node, where the computing node is configured to host one or more sessions concurrently.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, operations, or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving, by a computing device, first information relating to a current environment of a controller, wherein the controller comprises a plurality of user engageable interfaces, and wherein at least a portion of the user engageable interfaces are configured to be independently and selectively illuminated;
receiving, by the computing device, second information relating to a current operating state of one or more of the controller and a controlled device, wherein the current operating state comprises one or more of a location, an orientation, a relative position of the controller and the controlled device, and a use of the one or more of the controller and a controlled device;
determining, by the computing device, an illumination signature for the controller based at least in part on the received first information and the received second information; and
causing illumination of only a subset of the plurality of user engageable interfaces based upon the illumination signature.

2. The method of claim 1, wherein the first information comprises ambient light level.

3. The method of claim 1, wherein the first information comprises time of day, weather conditions, ambient sound level, or premises security state, or a combination thereof.

4. The method of claim 1, wherein the first information is received from a sensor co-located with the controller, a sensor co-located with the controlled device, a second device configured to be controlled by the controller, a premises security system, a communication gateway, or a network device, or a combination thereof.

5. The method of claim 1, wherein user engageable interfaces comprise one or more of back-lit keys and a touch screen.

6. The method of claim 1, wherein the second information is received from a sensor co-located with the controller, a sensor co-located with the controlled device, a second device configured to be controlled by the controller, a premises security system, a communication gateway, or a network device, or a combination thereof.

7. The method of claim 1, wherein the illumination signature represents a pattern of conditional values relating to at least the environment and operating state of the controller.

8. The method of claim 1, wherein the illumination signature is based at least in part on one or more of historical data for the controller, predictive data for the controller, and aggregated data with at least one other controller.

9. The method of claim 1, wherein the causing illumination of only the subset of the plurality of user engageable interfaces comprises causing illumination in a pre-determined illumination pattern.

10. A controller comprising:
a housing;
a communication element disposed adjacent the housing and configured to transmit a signal for controlling operations of a controlled device;
a plurality of user engageable interfaces disposed adjacent the housing, wherein at least a subset of the user engageable interfaces is configured to be independently and selectively illuminated, wherein the user engageable interfaces are configured to be activated by a user to cause the signal to be transmitted for controlling operations of the controlled device; and
a processor disposed within the housing and configured to receive information relating to one or more of an environment of the controller and an operating condition of the controller, and to cause illumination of a portion of the plurality of user engageable interfaces based upon received information, wherein the environment comprises one or more of ambient light, time of day, weather conditions, ambient sound level, or premises security state, or a combination thereof, and wherein the operating state comprises one or more of a location, an orientation, a relative position to a controlled device, and a use of the controller.

11. The controller of claim 10, wherein user engageable interfaces comprise one or more of back-lit keys and a touch screen.

12. The controller of claim 10, wherein the illumination of the portion of the plurality of user engageable interfaces comprises illumination in a pre-determined illumination pattern.

13. The controller of claim 10, wherein the information is received from a sensor disposed adjacent the housing of the controller, a device configured to be controlled by the controller, a premises security system, a communication gateway, or a network device, or a combination thereof.

14. A method comprising:
receiving, by a computing device, first information relating to a current environment of a controller, wherein the controller comprises a plurality of user engageable interfaces, and wherein at least a subset of the user engageable interfaces is configured to be independently and selectively illuminated;
receiving, by the computing device, second information relating to a current operating state of one or more of the controller and a controlled device; and
causing selective emphasis of a portion of the plurality of user engageable interfaces based upon at least the first information and the second information.

15. The method of claim 14, wherein the first information comprises ambient light level, time of day, weather conditions, ambient sound level, or premises security state, or a combination thereof.

16. The method of claim 14, wherein the current operating state comprises one or more of a location, an orientation, a relative position of the controller and the controlled device, and a use of the one or more of the controller and the controlled device.

17. The method of claim 14, wherein the first information is received from a sensor co-located with the controller, a sensor co-located with the controlled device, a second device configured to be controlled by the controller, a premises security system, a communication gateway, or a network device, or a combination thereof.

18. The method of claim 14, wherein the causing emphasis of the portion of the plurality of user engageable interfaces comprises one or more of causing illumination of the portion of the plurality of user engageable interfaces in a pre-determined illumination pattern and causing re-sizing of the portion of the plurality of user engageable interfaces relative to another portion of the plurality of user engageable interfaces.

19. The method of claim 18, wherein the pre-determined illumination pattern represents a notification message.

20. The method of claim 14, further comprising determining, by the computing device, one or more interfaces of the of the plurality of user engageable interfaces that are necessary based upon at least the first information and the second information, wherein the portion of the plurality of user engageable interfaces that is caused to be emphasized comprises the one or more interfaces of the of the plurality of user engageable interfaces determined to be necessary.
